(19) United States
(12) Patent Application Publication
(10) Pub. No.: US 2011/0214490 A1
(43) Pub. Date: Sep. 8, 2011

(54) Water leak detector

(76) Inventor: Masami Sakita, San Francisco, CA (US)

(21) Appl. No.: 12/660,641

(22) Filed: Mar. 2, 2010

(51) Int. Cl. G01N 5/02

(52) U.S. Cl. 73/73

(57) ABSTRACT

The preferred embodiment of the water leak detector of the present invention comprises a detection device and at least one water sensor. The water sensor includes a pair of elastic conductive metal tapes affixed to at least one tape-like water absorber made of a thin water absorbing material, a socket to which the pair of conductive tapes is plugged into, and a sliding shoe to which the tip of the metal tapes are plugged into. The water absorber is dipped into a salt water pond in the production process so that it includes salt within and on its surface. The detection device includes a housing; a battery socket; an alarm; a toggle switch; a push button switch; and a pair of cables that connects the detection device with the water sensor.

### FIELD OF THE INVENTION

This invention relates generally to a water leak detector, and more particularly that is used to detect water leak in the attic or the space between the ceiling and the upstairs floor.

### BACKGROUND OF THE INVENTION

The water leak is a common problem in many buildings, and the problem usually becomes more serious as the building becomes older. The leak can occur in the roof, in the cold/hot water pipes and the drain pipe. Finding the source of a water leak in the multi-story building can be difficult especially when the water leak is detected in a spot the water leak is not expected: the water could come from the roof or any of the pipes in higher floors. Or in some cases, water leaks are not detected for a long time if the amount of leaked water is small. These water damages could cause growth of the mold while the occupants of the building not being aware of it. Stationary water leak detectors available in the market are able to detect water leaks on the floor, but none of those detectors is able to detect water leaks of the kind described above unless the ceiling is opened up and the detector is installed above the ceiling or the attic. A stationary water leak detector that is able to detect leaked water in the space between the floors or the attic is needed.

### OBJECTS OF THE INVENTION

An object of this invention is the provision of a water leak detector that is able to detect water leaks in normally inaccessible space such as that between the ceiling and the upstairs floor, and the attic in which an insulation material is not disposed, and that does not require opening up of the ceiling in the installation of the detector.

An object of this invention is the provision of a water leak detector that is able to detect a small amount of water leaks.

### SUMMARY OF THE INVENTION

The preferred embodiment of the water leak detector of the present invention comprises a detection device and at least one water sensor. The water sensor includes a pair of elastic conductive metal tapes and at least one water absorber that has an appearance of a tape and made of water absorbing material, and to which water absorber, the elastic conductive metal tapes are affixed to; a socket into which the pair of elastic conductive metal tapes is plugged; and a sliding shoe into which the tip of the elastic conductive metal tapes are plugged. The tape-like water absorber is dipped into a salt water pond in the production process so that the water absorber includes salt within and on its surfaces. The socket includes two cables connected to the receptors of the metal tapes in one end and connected to cables that extend from the detection device in the other end. The detection device includes a housing; a battery socket; an alarm; a toggle switch; a push button switch; and a pair of cables that connects the detection device with the cables of the socket to the water sensor.

### BRIEF DESCRIPTION OF THE DRAWINGS

The above description and other objects and advantages of this invention will become more clearly understood from the following description when considered with the accompanying drawings. It should be understood that the drawings are for purposes of illustration only and not by way of limitation of the invention. In the drawings, like reference characters refer to the same parts in the several views:

FIG. 1A is a water sensor tape of a prior art of non-adhesive type, and FIG. 1B a water sensor tape of adhesive type adhered to a flat surface;

FIG. 2 is a cross-sectional view of the water leak detector of the preferred embodiment;

FIG. 3A is a bottom view, FIG. 3B a side view, FIG. 3C a rear view, and FIG. 3D a cross sectional view of the water sensor of the preferred embodiment of the water leak detector;

FIG. 4A is a bottom view of the water sensor in a sample application, and FIG. 4B an expanded view around the hole made on the ceiling in the sample application; and

FIG. 5A is a side view depicting the installation of the sensor, and FIG. 5B an expanded view of a sliding shoe.

### DETAILED DESCRIPTION OF THE INVENTION

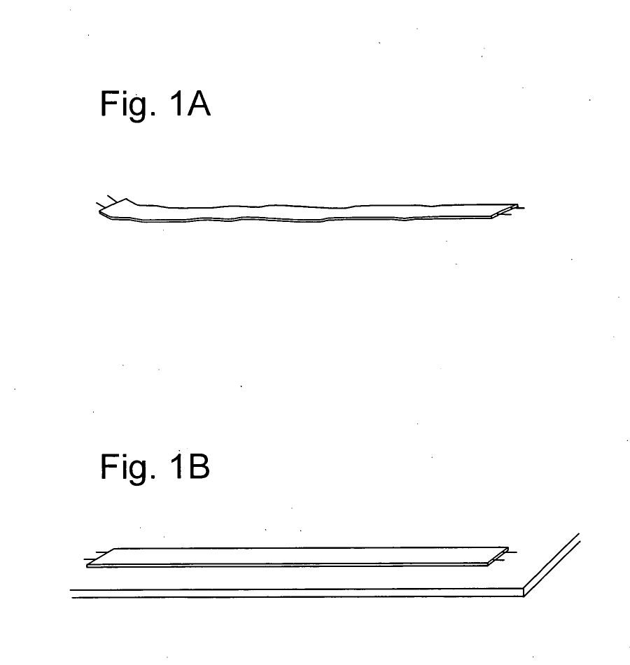

The prior art of the water sensor that is closest in design to that of the present invention uses a water sensor tape as shown in FIG. 1A, of which improved version shown in FIG. 1B has been said to be on the market for about four decades. In both cases, the tape includes a pair of conductive wires sandwiched by two tapes made of a water absorbing material. The difference between these two is that the tape shown in FIG. 1B has adhesive on one side and that shown in FIG. 1A does not. The non adhesive tape can have bridging effect, which allows water to flow under it, and thus is considered not too effective. The water sensor of these types is used to detect water leak on the floor, subfloor and in pipes. It must be apparent that the water sensor tape of either type cannot be effectively installed in the space above the ceiling.

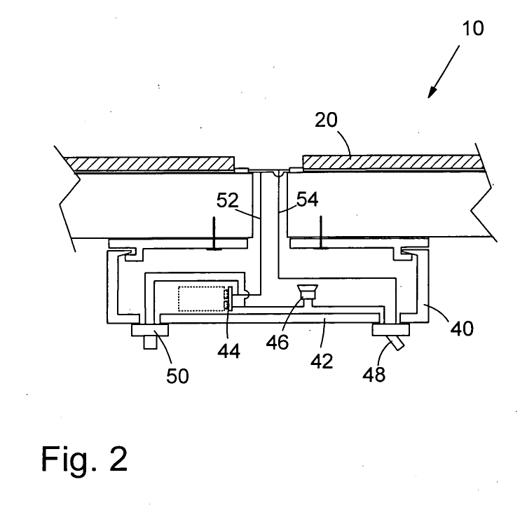

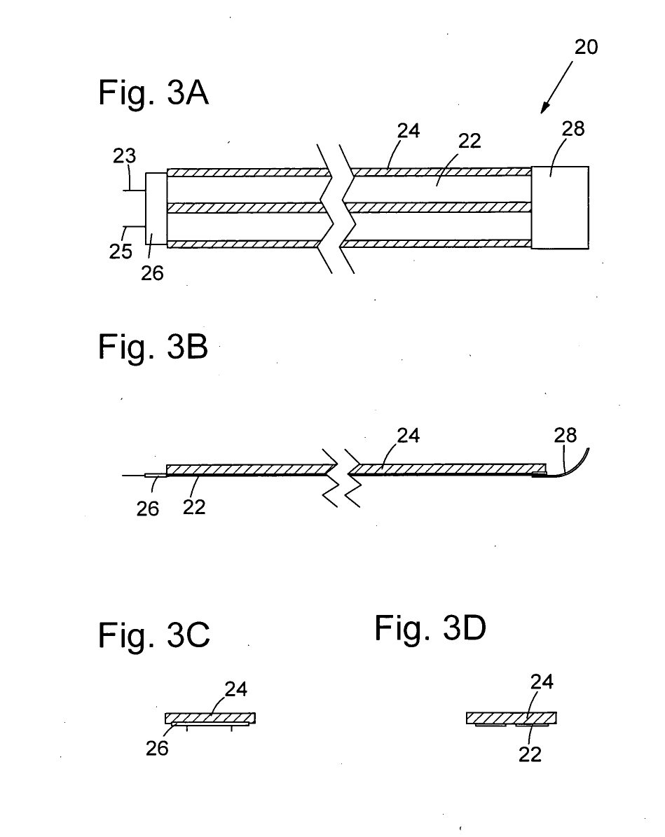

As shown in FIG. 2, the preferred embodiment of the water leak detector 10 of the present invention comprises a detection device 40 and at least one water sensor 20. As shown in FIGS. 3A through 3D, the water sensor 20 includes a pair of elastic conductive metal tapes 22 and at least one water absorber 24 that has an appearance of a tape, and is made of a water absorbing material, and to which water absorber 24, the elastic conductive metal tapes are affixed; a socket 26 into which the pair of elastic conductive metal tapes 22 is plugged; and a sliding shoe 28 into which the tip of the metal tapes 22 are plugged. The water absorber 24 is dipped into a salt water pond in the production process so that the tape includes salt within and on its surfaces. The socket 26 includes two cables 23 and 25, one 23 of the cables is connected to the socket's receptor for one conductive metal tape 22 in one end and connected to one of the two cables that extend from the detection device 40 in the other end, and the other one 25 of the cables is connected to the socket's receptor for another conductive metal tape 22 in one end and connected to the other one of the two cables that extend from the detection device in the other end.

A few variations of the water absorber's design are possible. The water absorber 24 may be a flattened tube, and the two elastic conductive metal tapes 22 may be affixed to the internal surface of a flattened tube-shaped water absorber 24; or the two elastic conductive metal tapes 22 may be affixed to the water absorber 24 in such a manner that the water absorber 24 wraps around the two elastic conductive metal tapes 22; or the two elastic conductive metal tapes 22 may be affixed to one side of the water absorber 24 of flattened tube construction; or one water absorber 24 may be affixed to each side of the elastic conductive metal tapes 22.

In an alternative embodiment, the water absorber is not dipped into the salt pond. In another embodiment, both the water absorber 24 and the elastic conductive metal tapes 22 are dipped into the salt water pond—doing so could corrode the metal tape, if they are made of high carbon steel, and that will improve conductivity. The length of the water sensor 20 of any of these designs is adjustable by simply cutting it, and attaching the socket in one end and the sliding shoes in the other end.

The detection device includes a housing 42; a battery socket 44; an alarm 46; a toggle switch 48; a push button switch 50 (see FIG. 2); and a pair of cables 52 and 54 that connects the detection device with the cables of the socket 26 of the water sensor 20. The alarm 46 is set off when the water between a pair of the elastic conductive metal tapes 22 closes the electric circuit that includes the battery socket 44, the alarm 46, and the toggle switch 48. When the alarm 46 is set off, switch off the water leak detector using the toggle switch 48. To test the battery, push the push switch 50: if the alarm 46 sets off, the battery is alive.

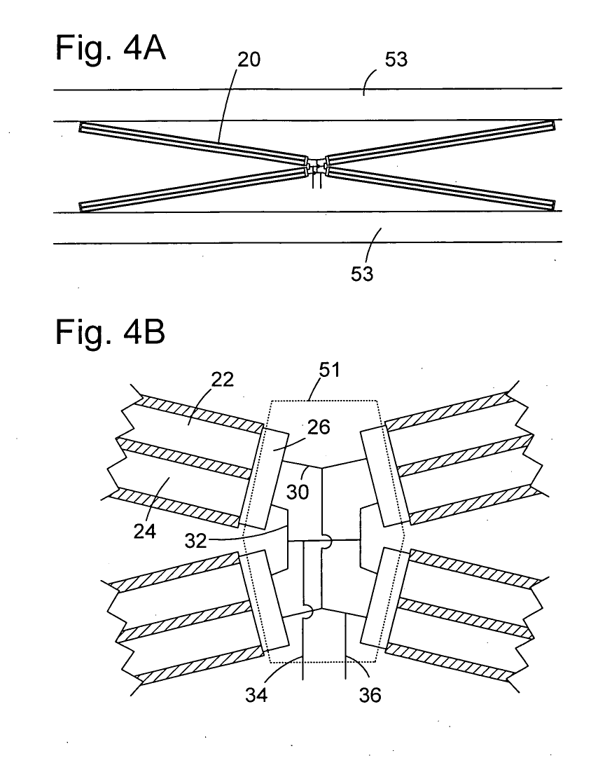

At least one sensor is used per application. It is more effective to use a plurality of water sensors, and most effective if four water sensors 20 are used diagonally as shown in FIGS. 4A and 4B as the area covered by the water sensors 20 is usually limited by neighboring beams 53. In an application that uses more than one sensor, the sensors are connected together in such a manner that one wire 30 coming out of each socket 26 is connected together, and then connected to one wire 36; and the other wire 32 coming out of each socket 26 is connected together, and then connected to the other wire 34. The wire 34 of the water sensor 20 is connected to the wire 52 of the detection device 40, and the other wire 36 the water sensor 20 is connected to the other wire 54 of the detection device 40.

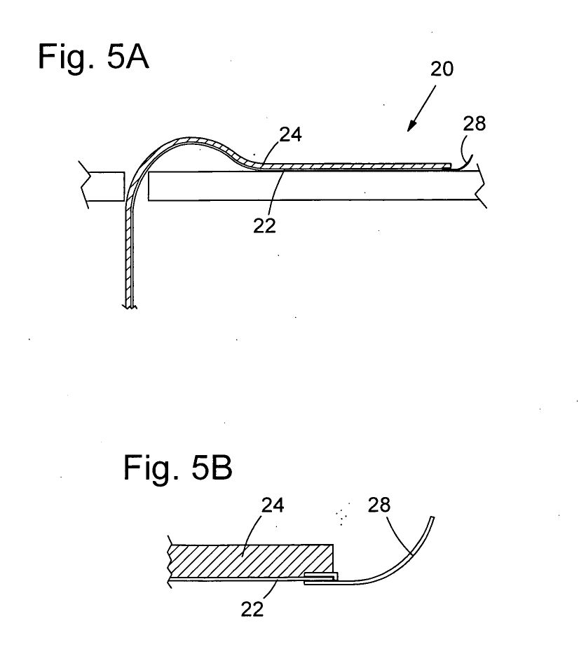

In order to detect water leak in the space above the ceiling, the water sensor 20 must be installed in the space above the ceiling. Installation of the water sensor 20 in the space above the ceiling includes opening of a hole 51 in the ceiling that is barely large enough to push the tape-shaped water sensor 20 through. The tape-shaped water sensor 20 is bendable but rigid enough so that the installer is able to push the tape-shaped water sensor 20 deep into the space above the ceiling. When the distal end of the water sensor 20 reaches the furthest point the installer wanted or the space allows, he/she cuts the tape-shaped sensor in such a manner that the proximal end of the water sensor will barely reach the hole in the ceiling, and plug in the metal tapes 22 into a socket 26. To avoid the tip of the sensor is caught by a bump or debris and gets stuck, the water sensor includes the sliding shoe 28 attached at the tip of the sensor (see FIGS. 3A, 3B, 5A and 5B).

The invention having been described in detail in accordance with the requirements of the U.S. Patent Statutes, various other changes and modifications will suggest themselves to those skilled in this art. It is intended that such changes and modifications shall fall within the spirit and scope of the invention defined in the appended claims.

I claim:

1. A water leak detector comprising a detection device and at least one water sensor wherein
said water sensor includes a pair of elastic conductive metal tapes and at least one water absorber that has an appearance of a tape and made of a water absorbing material, and
said pair of elastic conductive metal tapes is affixed to said water absorber.

2. A water leak detector as defined in claim 1 wherein
said water sensor includes a socket into which one end of said pair of elastic conductive tapes is plugged.

3. A water leak detector as defined in claim 1 wherein
said water absorber is dipped into a salt water pond in the production process so that said water absorber made of a water absorbing material includes salt within and on said water absorber's surfaces.

4. A water leak detector as defined in claim 1 wherein said water absorber is of flattened tube construction.

5. A water leak detector as defined in claim 4 wherein said elastic conductive metal tapes are affixed to internal surface of said flattened tube.

6. A water leak detector as defined in claim 1 wherein said water absorber wraps around said elastic conductive metal tapes.

7. A water leak detector as defined in claim 1 wherein said water absorber is affixed to each side of each of said elastic conductive metal tapes.

8. A water leak detector as defined in claim 1 wherein
said water sensor is elastic enough and rigid enough to push it into a hole made on the ceiling in the installation of said water leak detector to detect leaked water above the ceiling.

9. A water leak detector as defined in claim 1 wherein
said detection device includes a housing, a battery socket, an alarm, a toggle switch, a push button switch, and a pair of cables that connects said detection device with said water sensor.

10. A water sensor of a water leak detector comprising a detection device and at least one water sensor wherein
said water sensor includes a pair of elastic conductive metal tapes and at least one water absorber that has an appearance of a tape and made of a water absorbing material, and
said pair of elastic conductive metal tapes is affixed to said water absorber.

11. A water sensor of a water leak detector as defined in claim 10 wherein
said water sensor includes a socket into which one end of said pair of elastic conductive tapes is plugged.

12. A water sensor of a water leak detector as defined in claim 10 wherein
said water absorber is dipped into a salt water pond in the production process so that said water absorber made of a water absorbing material includes salt within and on said water absorber's surfaces.

13. A water sensor of a water leak detector as defined in claim 10 wherein
said water absorber is of flattened tube construction.

14. A water sensor of a water leak detector as defined in claim 14 wherein said elastic conductive metal tapes are affixed to internal surface of said flattened tube.

15. A water sensor of a water leak detector as defined in claim 10 wherein said water absorber wraps around said elastic conductive metal tapes.

16. A water sensor of a water leak detector as defined in claim 10 wherein said water absorber is affixed to each side of each of said elastic conductive metal tapes.

17. A water sensor of a water leak detector as defined in claim 10 wherein
said water sensor is elastic enough and rigid enough to push it into a hole made on the ceiling in the installation of said water leak detector to detect leaked water above the ceiling.

18. A detection device of water leak detector comprising a detection device and at least one water sensor wherein
said water sensor includes a pair of elastic conductive metal tapes and at least one water absorber that has an appearance of a tape and made of a water absorbing material, and
said pair of elastic conductive metal tapes is affixed to said water absorber, and
said detection device includes a housing, a battery socket, an alarm and a pair of cables that connects said detection device with said water sensor.

19. A detection device of a water leak detector as defined in claim 18 wherein
said detection device includes a toggle switch.

20. A detection device of a water leak detector as defined in claim 18 wherein
said detection device includes a push button switch.
